(19) United States
(12) Patent Application Publication
(10) Pub. No.: US 2003/0116004 A1
(43) Pub. Date: Jun. 26, 2003

(54) Hole puncher

(76) Inventors: Masayuki Tanaka, Uji (JP); Hiroyuki Onitsuka, Bisai (JP); Koji Kirino, Bisai (JP); Tomoyuki Washizu, Ichinomiya (JP); Masaaki Sumi, Gifu (JP); Takeshi Arihara, Kyoto (JP)

Correspondence Address: BEYER WEAVER & THOMAS LLP, P.O. BOX 778, BERKELEY, CA, 94704-0778, US

(21) Appl. No.: 10/287,465

(22) Filed: Nov. 1, 2002

(30) Foreign Application Priority Data
Nov. 5, 2001 (JP) 2001-339413

(51) Int. Cl. B26D 1/12

(52) U.S. Cl. 83/669

(57) ABSTRACT

A hole punch has a punching unit with a rotatable punch for punching a hole through a paper sheet, a die which is rotatable in synchronism with the punch and a paper transporting device for transporting the paper sheet from an upstream side to a downstream side generally in a specified direction of paper transportation. The transporting device includes a paper supplying device and a paper discharging device respectively on the upstream and downstream side of the punching unit for supplying and discharging the paper sheet towards and away from the punching unit. The paper supplying device has a clamping device for clamping the paper sheet at a distance x1 away from the punching position where a hole is punched by the punch. The paper discharging device has another clamping device at a distance x2 away from the punching position. At least one of the distances x1 and x2 is made smaller than the distance of the first hole punched through the paper sheet by the punching unit from the front edge of the paper sheet. There is a guide member for a side edge of the paper sheet to slide along as the paper sheet is transported. Oblique clamping devices on the upstream side of the punching unit serve to apply an oblique force on the paper sheet with respect to the direction of paper transportation and to press the paper sheet onto the guide member.

### BACKGROUND OF THE INVENTION

This invention relates to a hole puncher for a sheet of paper. This invention relates in particular to such a hole puncher capable of improving the quality of the punched holes.

Prior art methods of punching holes include the method of using a rotary punch as partially described in Japanese Patent Publication Tokkai 2000-42994, the method of using a press punch as partially described in Japanese Patent Publication Tokkai 10-7307 and the so-called rotary punch method for punching a hole while causing a punch and a die to rotate through gears. When such methods are used, it is commonly done to align a plurality of punches perpendicularly to the direction in which paper sheets are transported such that a plurality of holes can be punched simultaneously. With such a prior art method, the size of the punch unit can be reduced only within a limited extent because it is comprised of a plurality of punches and the number of holes to be punched at the same time was fixed according to the number of punches in the punch unit.

In view of the above, it has been attempted to use a punch unit including only one punch and to repeat the punching operation several times while each paper sheet is passed by such that the size of the punch unit can be reduced or to punch a plurality of holes in the direction of transportation of the paper sheet by means of a single punch unit at a fixed position. In such a case, however, the punched hole can be easily torn and burrs are likely to result because the paper sheets tend to flutter. Variations also tend to be large in the position of the punched holes and hence a mechanism is needed for keeping the distance of the hole constant from an edge parallel to the direction of motion of the paper sheet. In summary, it has been difficult to maintain a high quality of punched holes.

### SUMMARY OF THE INVENTION

It is therefore an object of this invention to provide a hole puncher and a method of punching holes in paper sheets capable of improving the quality of punched holes.

A hole puncher according to this invention comprises a punching unit having a rotatable punch for punching a hole through a paper sheet and means for transporting the paper sheet to and from the punching unit. In one aspect of the invention, the hole puncher is characterized in that the paper sheet is prevented from fluttering by means of rollers for transporting the paper sheet positioned appropriately closely to where the punching takes place.

Explained more in detail, the part of the means for transporting the paper sheet that supplies it to the punching unit may be referred to as a paper supplying device and the part that discharges it from the punching unit may be referred to as the paper discharging device. Both the paper supplying device and the paper discharging device include clamping members such as rollers for clamping the paper sheet in between. Let x1 and x2 respectively represent the distance between the punching position where a hole is punched by the punching unit and the position of the clamping members of the paper supplying device and the paper discharging device closest to the punching unit.

Furthermore, let T1 be the distance between the position of the first hole punched through the paper sheet by the punch and the front edge of this paper sheet which reaches the punching unit first as the paper sheet is transported to it by the paper supplying means. According to the invention, the hole puncher is characterized wherein least one of x1 and x2 is less than T1.

The invention may be characterized alternatively wherein at least one selected from the paper supplying device and the paper discharging device has a clamping device such as rollers disposed away from the punching position by a distance which is less than T1.

The paper transporting means may be controlled such that the speed of transportation by the paper discharging device is greater than that by the paper supplying device and the force of clamping by the paper discharging device may be controlled to be less than that by the paper supplying device so as to suppress the fluttering of the paper sheet as it is punched.

The hole puncher of this invention may be further characterized in that the rotatable punch is provided with a holder member which may be made of an elastic material for clamping and holding the paper sheet while a hole is punched therethrough and that there is also provided a die which is rotatable in synchronism with the punch. In order to prevent the paper sheet from becoming folded as it is punched, the contact surface of the holder member is made shorter than the die both in the direction of paper transportation and in the perpendicular direction. The opposite surface of the holder member not contacting the paper sheet need not be made smaller than the die because such a surface will not contact the paper sheet and hence will not function to cause the paper sheet to become folded.

In another aspect of the invention, the hole puncher may be characterized as having a guide member extending in the direction of the paper transportation. Some of the aforementioned means for transporting the paper sheet may be referred to as an oblique clamping devices which may include a cylindrically shaped roller with its shaft oriented not exactly perpendicularly to the direction of paper transportation, or that of the guide member, but obliquely by making a specified angle with the perpendicular direction such that a force in a direction transverse to the direction of paper transportation will be exerted on the paper sheet and the paper sheet will be thereby pushed towards the guide member and its side edge will slide against it as the paper sheet is transported to the punching unit.

The hole puncher of this invention is further characterized as also including a straight transportation device which may include rollers with shafts extending exactly perpendicularly to the direction of paper transportation, or the guide member, for transporting the paper sheet straight in the direction of the paper transportation. This is disposed closer to the punching unit than any of the other paper transporting devices including the aforementioned oblique clamping devices such that the paper sheet, having been pushed towards the guide member, is caused to reach the punching unit by moving straight in the direction of paper transportation.

It is preferable that the distance of paper transportation along the specified direction of paper transportation be longer than the length of any paper sheet intended to be used on this hole puncher such that the transverse position of even a paper sheet with the longest admissible length can be corrected towards the guide member and holes can be punched at a position at a specified distance from its side edge.

With a hole puncher designed as described above according to this invention, a hole can be punched reliably through a paper sheet at an intended position without causing the paper sheet to flutter such that a hole can be punched neatly without unwanted burrs.

### BRIEF DESCRIPTION OF THE DRAWINGS

FIG. 1 is a schematic side view of a paper processing apparatus incorporating this invention.

FIG. 2 is a front view of the paper processing apparatus of FIG. 1 taken in the direction of arrow S in FIG. 1.

FIGS. 3A and 3B, together referred to as FIG. 3, are each a drawing for showing a design for the oblique rollers.

FIG. 4 is a schematic side view of the hole punching unit of the paper processing apparatus shown in FIG. 1.

FIG. 5 is a diagonal external view of the punch unit of FIG. 1.

FIG. 6 is a diagonal view of the punch of FIG. 5.

FIG. 7 is another diagonal view of the punch unit of FIG. 1.

FIG. 8 is a block diagram of the paper processing apparatus of FIG. 1.

FIG. 9 is a detailed side view of the punch unit.

FIGS. 10A and 10B, together referred to as FIG. 10, are plan views of paper sheets of different sizes each having three holes punched therein.

FIG. 11 is a flowchart for the operation of the paper processing apparatus of FIG. 1.

FIGS. 12A, 12B and 12C, together referred to as FIG. 12, show the punching operation by the punch and the die of the punch unit, respectively showing the moment when the punching is about to start, the time of punching and the moment at the end of the punching operation.

FIG. 13 is a detailed flowchart for Step S3 in the flowchart of FIG. 11.

FIG. 14 is a diagram for showing the speed of rotation of the punch in the punch unit of FIG. 7.

### DETAILED DESCRIPTION OF THE INVENTION

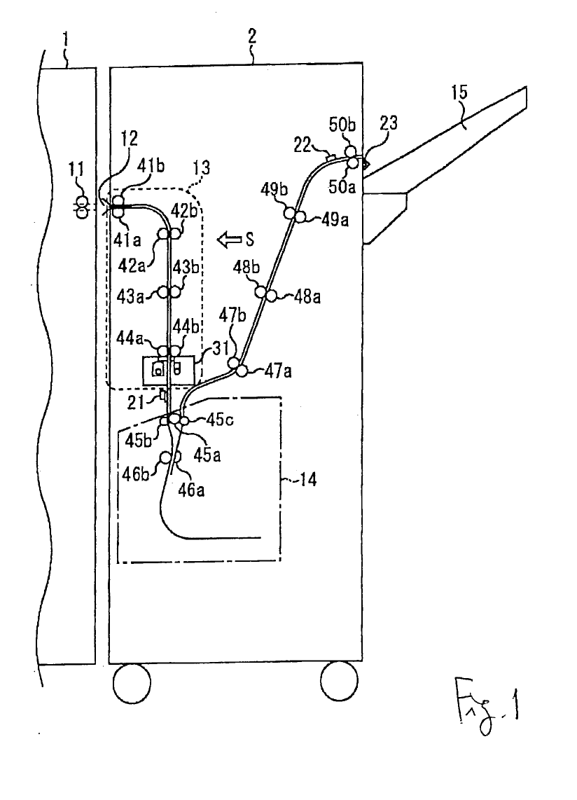

The invention is described next by way of examples. FIG. 1 shows an image forming apparatus 1 and the general structure of a paper processing apparatus 2 making use of a hole puncher according to this invention.

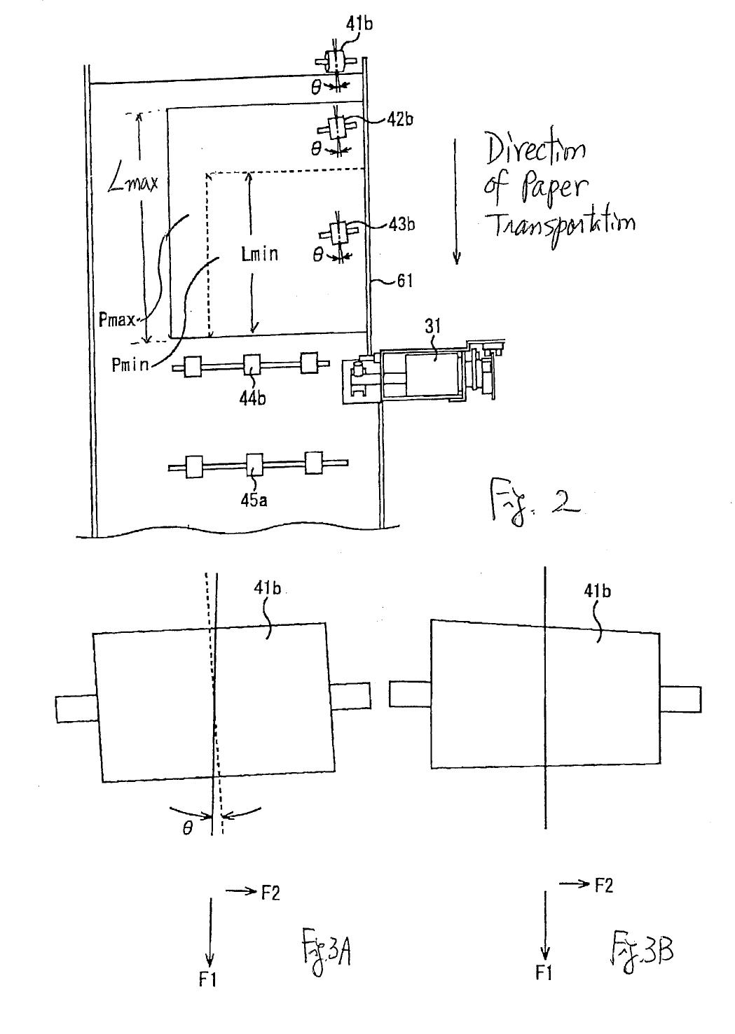

The image forming apparatus 1 may be a printer, a copier or a facsimile machine. Sheets of paper printed thereby are adapted to be discharged therefrom by means of its discharge rollers 11 towards the paper processing apparatus 2. A paper sheet discharged through these discharge rollers 11 and received by the paper processing apparatus 2 through its paper receiving opening 12 is shown in FIG. 2 and indicated as Pₘₐₓ (for a large size sheet) or Pₘᵢₙ (for a small size sheet) and is adapted to be received with its side edge guided along a guide plate 61 extending in the direction of its transportation. For the convenience of disclosure, FIG. 1 shows the image forming apparatus 1 and the paper processing apparatus as if they were separated. In actual operations, however, they are intended to be attached to each other.

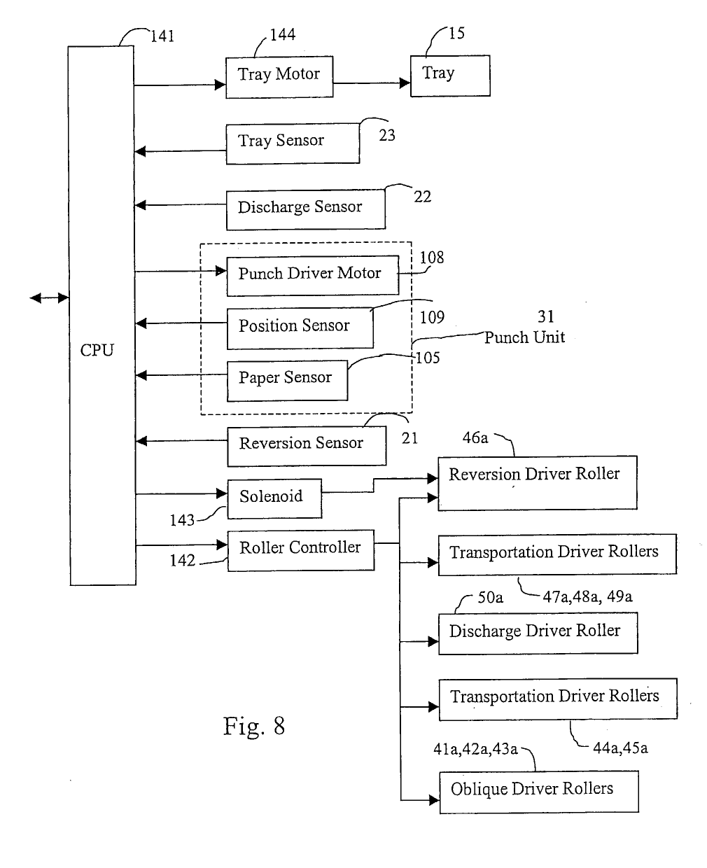

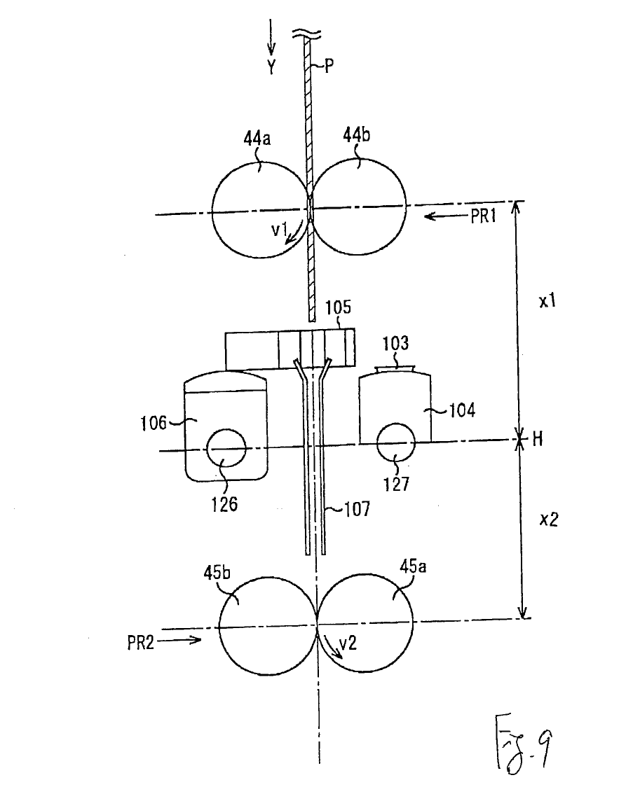

The paper processing apparatus 2 not only has the paper receiving inlet 12 but also includes a hole punching unit 13 for transporting a paper sheet from the paper receiving inlet 12 and punching holes in it, a motion reversing unit 14 for reversing the direction of motion of the paper sheet, a tray 15 for receiving discharged paper sheets, sensors for detecting paper sheets and rollers for transporting each paper sheet. The sensors include a reversion sensor 21, a discharge sensor 22 and a tray sensor 23, each serving to detect a paper sheet being transported along a transportation path where it is installed. The rollers include oblique rollers 41-43, transportation rollers 44, 45 and 47-49, and reversion rollers 46 and discharge rollers 50, each set of rollers consisting of a driver roller (with letter “a” following a numerical indicator) and a follower roller (with letter “b” or “c” following a numerical indicator). Each driver roller is driven by a corresponding motor controlled by a control unit (shown at 142 in FIG. 8) and is made of a highly frictional material such as rubber. Each follower roller is for being pressed against a corresponding one of the driver rollers so as to sandwich a paper sheet in between with a specified pressure and is made of a less frictional material such as a plastic material.

The hole punching unit 13 is comprised of a punch unit 31 and a series of oblique rollers 41-43 and transportation rollers 44 disposed sequentially along a paper transportation path defined between the paper receiving inlet 12 and the punch unit 31.

The motion reversing unit 14 is comprised of a transportation roller 45 (consisting of a transportation driver roller 45a and transportation follower rollers 45b and 45c) and a reversion roller 46 (consisting of a semicircular reversion driver roller 46a and a reversion follower roller 46b). Transportation rollers 47-49 (each consisting of a driver roller 47a, 48a or 49a and a follower roller 47b, 48b or 49c) and a discharge roller 50 (consisting of a discharge driver roller 50a and a discharge follower roller 50b) are sequentially disposed between the motion reversing unit 14 to the tray 15.

A paper sheet discharged from the discharge roller 11 of the image forming apparatus 1 is first received through the paper receiving inlet 12 by the oblique roller 41 of the hole punching unit 13 and is then transported to the punch unit 31 by the oblique rollers 42 and 43 and the transportation rollers 44. Holes are then punched therein by the punch unit 31 (as will be described in detail below) and the punched paper sheet is then transported to the motion reversing unit 14.

Inside the motion reversing unit 14, the paper sheet is moved downward in the downstream direction by means of the transportation driver and follower rollers 45a and 45b. When a specified length of time has passed after the back edge of the paper sheet is detected by the reversion sensor 21 disposed between the hole punching unit 13 and the motion reversing unit 14 the back edge of the paper sheet has passed the position between the transportation driver and follower rollers 45a and 45b, a stopper (not shown) controlling the rotation of the shaft of the reversion driver roller 46a is removed by means of a solenoid (shown at 143 in FIG. 8) such that the reversion driver roller 46a begins to rotate.

As explained above, the reversion driver roller 46a is semicircularly shaped. As the paper sheet is transported to the reversion driver and follower rollers 46a and 46b and until its back edge passes their position, the reversion driver roller 46a has its straight peripheral portion facing the transportation path and hence does not interfere with the passage of the paper sheet. When the solenoid 143 causes the shaft of the reversion driver roller 46a to rotate, the reversion driver roller 46a has its arcuate peripheral portion facing the transportation path to cause the paper sheet to be transported in the downstream direction towards the transportation driver and follower rollers 45a and 45c.

Thereafter, the paper sheet is transported further in the downstream direction by means of the transportation driver and follower rollers 46a and 46c, By these operations of the motion reversing unit 14, the direction of transportation of the paper sheet is reversed, or its back edge and front edge are reversed. As a result, the top surface of the paper sheet on which an image was formed by the image forming apparatus 1 is now a back surface. The paper sheet is thereafter transported sequentially by means of the transportation rollers 47-49 and discharged to the tray 15 by means of the discharge rollers 50. Right before the discharge rollers 50 is a discharge sensor 22. As the back edge of the paper sheet being discharged is detected by the discharge sensor 22, the transportation of the next paper sheet is started.

Since each paper sheet is flipped over inside the motion reversing unit 14, paper sheets which are discharged from the image forming apparatus 1 sequentially are piled up in the tray 15 without reversing the sequence. The tray 15 is mobile in the vertical direction by means of a belt (not shown) and a tray motor (shown at 144 in FIG. 8) and moves downward when the top surface of the paper sheets piled up in the tray 15 is detected by the tray sensor 23.

FIG. 2 is referenced next to explain the manner of transporting paper sheets inside the hole punching unit 13. Pₘᵢₙ indicates a paper sheet with a shortest length Lₘᵢₙ that can be handled by the paper processing apparatus 2. Pₘₐₓ indicates a paper sheet with a longest length Lₘₐₓ that can be handled by the paper processing apparatus 2. In what follows, FIG. 2 will be explained with reference to a paper sheet P with length L such that Lₘᵢₙ L Lₘₐₓ.

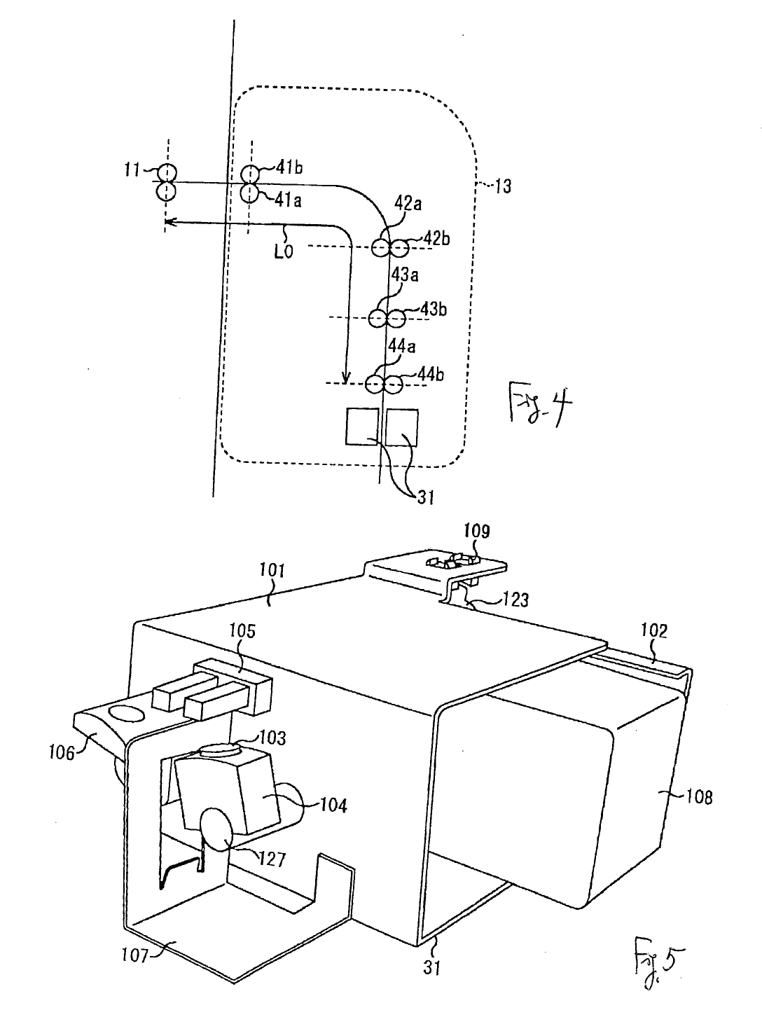

During the time interval from the moment when the back edge of the paper sheet P leaves the discharge rollers 11 of the image forming apparatus 1 until it enters the transportation rollers 44, the paper sheets P is transported by the oblique rollers 41-43 so as to move along the guide plate 61. As explained above, each set of the oblique rollers 41-43 consists of a driver roller 41a, 42a or 43a and a follower roller 41b, 42b or 43b. Since all these oblique rollers 41-43 are structured alike, the oblique rollers 41 will be described in detail next with reference to FIG. 3.

The oblique follower roller 41b may be set obliquely, with a small angle θ (such as 7.5°) from the direction of transportation of the paper sheets, as shown in FIG. 3A. The corresponding driver roller 41a is set normally, parallel to the direction of transportation. Thus, the paper sheet P in between is pressed onto the obliquely set follower roller 41b as it is driven by the driver roller 41a. In other words, the paper sheet P is transported by the principal force F1 in the direction of transportation by being pressed against the driver roller 41a but since the follower roller 41b is tilted, there is a perpendicular (or transverse) component of force F2, and the motion of the paper sheet P is corrected towards the guide plate 61. The perpendicular force component F2 can be obtained from the tilt angle θ, the pressure load and the friction force of the follower roller 41b and the friction force of the driver roller 41a. Alternatively, the follower roller 41a may be formed conically, as shown in FIG. 3B so as to be thinner in the direction toward the guide plate 61 such that a principal force F1 in the direction of transportation and a perpendicular component F2 as shown in FIG. 3A will result on the paper sheet sandwiched between the driver roller 41a and the follower roller 41b.

Thus, the horizontal position of the paper sheet P is corrected toward the guide plate 61 from the moment when its back edge passes the discharge rollers 11 of the image forming apparatus 1 by means of the oblique follower rollers 41b, 42b and 43b positioned at an angle θ. As a result, the paper sheet P comes to be accurately aligned such that the positions where holes are to be punched will be accurately set at a constant specified distance from the guide plate 61.

The paper sheet P, now thus aligned, is transported by the transportation rollers 44 towards the punch unit 31 affixed in the hole punching unit 13. The transportation follower roller 44b is set so as to transport the paper sheet P in the direction of transportation such that the positions of the holes to be punched will not be affected by the oblique follower rollers 41b, 42b and 43b or the transverse motion of the paper sheet caused thereby.

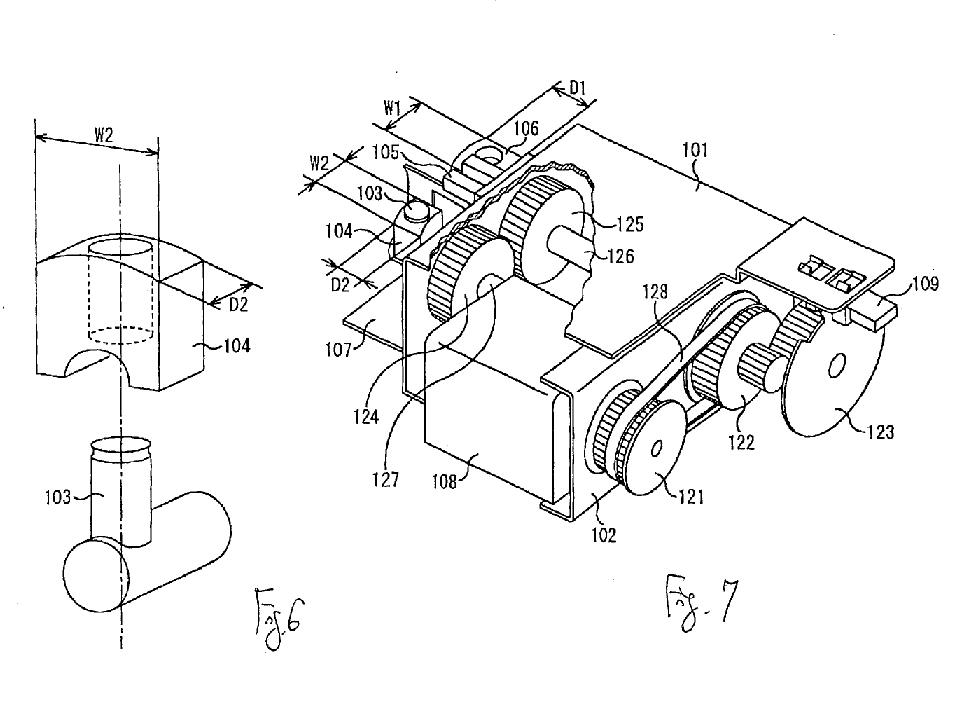

In FIG. 4, the distance L0 indicates the distance along the transportation path between the discharge rollers 11 of the image forming apparatus 1 and the transportation rollers 44a and 44b. From the moment when the back edge of the paper sheet P leaves the discharge rollers 11 of the image forming apparatus 1 until its front edge reaches the transportation rollers 44a and 44b, the paper sheet P is transported only by means of the oblique rollers 41, 42 and 43. In other words, the transverse position of the paper sheet P is corrected such that its side edge will travel along the guide plate 61 only over this distance of L0.

If the length L of the paper sheet P is longer than L0, this means that its front edge will be already between the transportation rollers 44a and 44b before its back edge is released from the discharge rollers 11 of the image forming apparatus 1 and hence that there is no range over the travel path of the paper sheet, that is, no distance over which the paper sheet P will be driven only by the oblique rollers 41, 42 and 43. In such a situation, the paper sheet P has no chance to have its transverse position corrected so as to come to travel against the guide plate 61. Thus, the distance L0 must be selected to be at least greater than L. In reality, L0 must be greater than L by an extra distance required for making the positional correction. This extra distance depends on factors such as the tilting angle θ, pressure load and friction of the oblique follower rollers 41b, 42b and 43b. With such extra distance taken into consideration, L0 must be made greater than Lₘₐₓ, the length of the longest paper sheet Pₘₐₓ intended to be handled by the paper processing apparatus 2. With L0 thus made sufficiently long, paper sheets of any length intended for the paper processing apparatus 2 can be adjusted reliably so as to end up traveling along the guide plate 61 by means only of the oblique rollers 41, 42 and 43.

FIG. 5 is referenced next to explain the structure of the punch unit 31 comprised of a first box element 101 and a second box element 102. A punch 103, a paper sensor 105, a die 106 and a paper guide 107 are disposed on the side of the first box element 101 facing the paper transportation path. A punch drive motor 108 is disposed so as to be surrounded by the first and second box elements 101 and 102. As shown more in detail in FIG. 6, the punch 103 is provided with a holder member 104 made of rubber for pressing the paper sheet down when a hole is being punched therein. The clamping member 104 may alternatively be made of sponge, or a member using a spring to be made elastic may be used for obtaining a similar effect.

The paper sensor 105 is a sensor of either the transmission type of the reflection type for obtaining data on the position of the paper sheet as a hole is punched therethrough. After the paper sensor 105 detects the front edge of the paper sheet and after a specified length of time depending on the size of the paper sheet and the number of holes to be punched has passed, the punch driver motor 108 causes the punch 103 and the die 106 to be rotated so as to complete a punching operation as the paper sheet is transported along the paper guide 107.

As shown more in detail in FIG. 7, the punch driver motor 108 of the punch unit 31 has a pulley 121 attached to it, and the motion of the punch driver motor 108 is communicated therefrom to a second pulley 122 through a belt 128 and from there further to a gear 123 connected to a shaft 126. Another gear 125 is attached to this shaft 126, and the gear 125 engages with still another gear 124 having another shaft 127. Shaft 126 is connected to the die 106 and shaft 127 is connected to the punch 103. Thus, the motion of the punch driver motor 108 is communicated to gear 124 through the pulleys 121 and 122 and the gear 125 such that the die 106 and the punch 103 are both rotated in a mutually correlated manner to carry out the punching process. In other words, the die 106 is in synchronism with the punch 103, and the die 106 and the punch 103 rotate in mutually opposite directions. The gear 123 serves also as an encoder. A notch is provided on the periphery of its flange, and its angular position is detected by a position sensor 109. The angular positions at which the punch 103 and the die 106 are stopped can thus be kept constant.

The control system for the paper processing apparatus 2 is explained with reference to the block diagram shown in FIG. 8. Its central processing unit (CPU) 141 serves to control the operation of the paper processing apparatus 2 as a whole on the basis of commands received from the image forming apparatus 1 or signals received from the reversion sensor 21, the discharge sensor 22, the tray sensor 23. the paper sensor 105 and the position sensor 109.

The control system includes a roller controller 142 serving to control the rotary motions of all of the driver rollers (the oblique driver rollers 41a, 42a and 43a, the transportation driver rollers 44a, 45a, 47a, 48a and 49a, reversion driver roller 46a and the discharge driver roller 50a) on the basis of the control from the CPU 141.

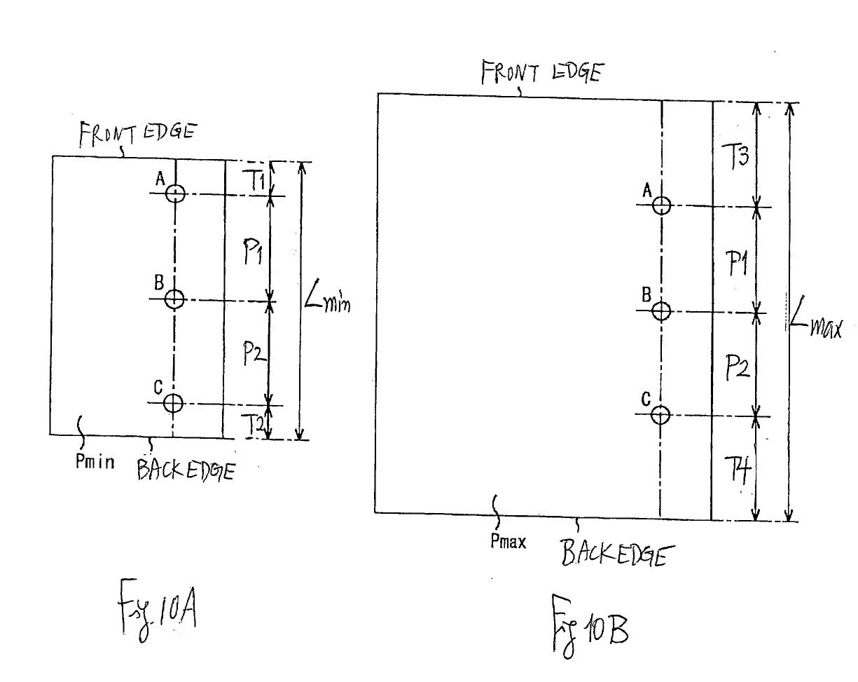

Next, the operations of the punch unit 31 are explained more in detail with reference to FIGS. 9 and 10. As shown in FIG. 9, a paper sheet P is delivered to the punch unit 31 between the transportation driver and follower rollers 44a and 44b in the direction indicated by arrow Y and passed between the transportation driver and follower rollers 45a and 45b. The hole position (or the punching position) H is the position where a hole is punched in the paper P by means of the die 106 and the punch 103. The distance from the contact position between the transportation driver and follower rollers 44a and 44b to the hole position H is defined as x1 and the distance from the hole position H to the contact position between the transportation driver and follower rollers 45a and 45b is defined as x2.

FIGS. 10A and 10B respectively show a paper sheet Pₘᵢₙ and Pₘₐₓ with the aforementioned minimum and maximum length Lₘᵢₙ and Lₘₐₓ that can be processed by the paper processing apparatus 2, each having three holes punched therein by the punch unit 31. In both FIGS. 10A and 10B, pitch P1 indicates the distance between the first and second holes and pitch P2 indicates the distance between the second the third holes punched in the paper sheet Pₘᵢₙ or Pₘₐₓ. Distances T1 and T2 are respectively the distance between the front edge and the first hole A and that between the third hole and the back edge of the paper sheet Pₘᵢₙ. Distances T3 and T4 are respectively the distance between the front edge and the first hole and that between the third hole C and the back edge of the paper sheet Pₘₐₓ. Normally, it is set such that T1=T2 and T3=T4.

The punch unit 31 is also set such that x1<T2 and hence that the paper sheet Pₘᵢₙ remains nipped by the transportation rollers 44 until the last (third) of the holes is punched in and that the fluttering of the paper sheet Pₘᵢₙ can be prevented. Similarly, it is so set that x2<T1 such that the paper sheet Pₘᵢₙ remains nipped by the transportation rollers 44 and 45 in front and at the back of the first punched hole A when it is punched and that the fluttering of the paper sheet Pₘᵢₙ can be prevented. Since the larger paper sheet Pₘₐₓ is also punched at the same pitches P1 and P2 and since T2<T4 and T1<T3, the following inequalities also hold: x1<T2<T4 and x2<T1<T3. Thus, the same effects as described above can be obtained with the larger paper sheet Pₘₐₓ.

As indicated also in FIG. 9, the peripheral speed of the transportation rollers 44 is defined as v1 and that of the transportation rollers 45 is defined as v2. Load PRI indicates the load force with which the follower roller 44b presses the driver roller 44a, and load PR2 indicates the load force with which the follower roller 45b presses the driver roller 45a. The gripping forces on the paper sheet P due to the loads PR1 and PR2 are respectively defined as G1 and G2 (not shown).

If v1<v2 and G1>G2, the paper sheet P is subjected to a tensile force by the transportation rollers 45 while it is nipped by the transportation rollers 44 and 45. Since G2 is smaller than G1, furthermore, the paper sheet P slips against the transportation rollers 45. This prevents the transportation rollers 45 from pulling the paper sheet P too strongly. In other words, the paper sheet P remains pulled without getting loose between the transportation rollers 44 and 45, and this condition serves to prevent the paper sheet P from fluttering and to allow holes to be punched in a stable manner.

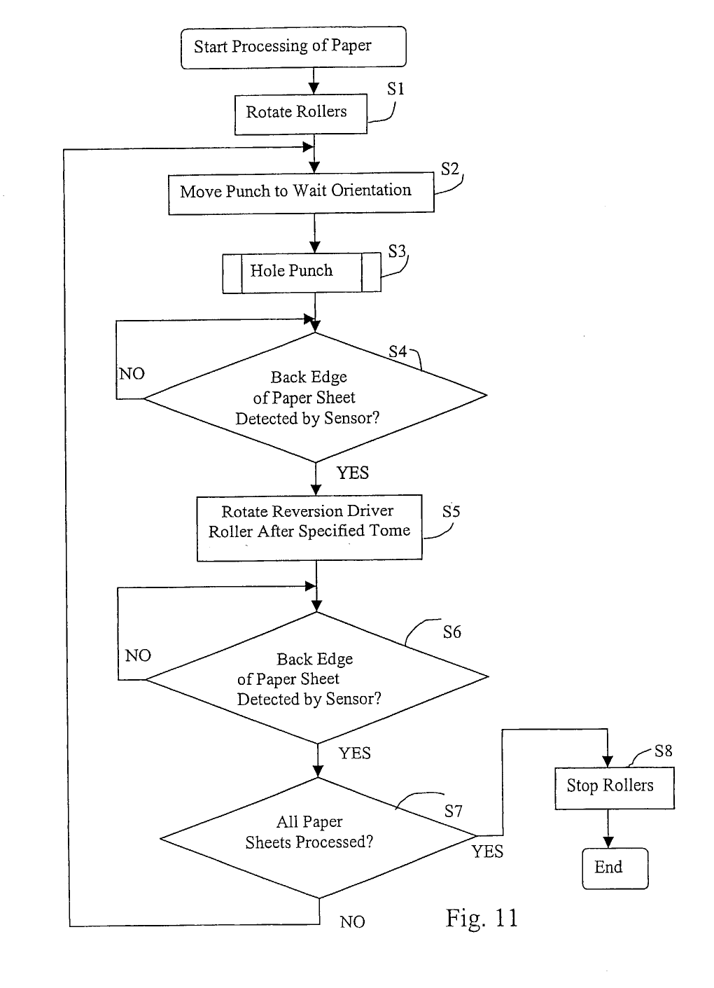

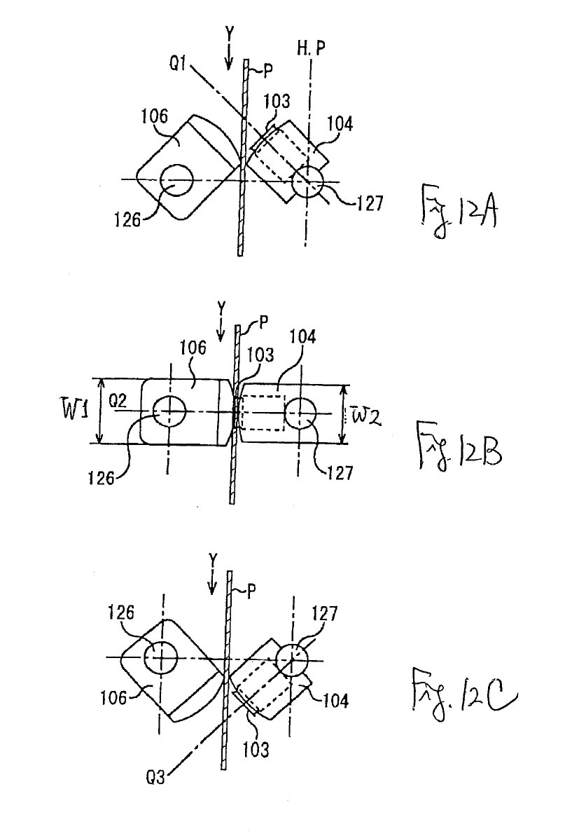

The processing by the paper processing apparatus 2 is explained next with reference to the flowchart shown in FIG. 11. When the CPU 141 receives a command from the image forming apparatus 1 that a punching process should be started, together with data such as the size of the paper sheet P and the number of holes to be punched, the roller controller 142 is controlled so as to cause all driver rollers (the oblique driver rollers 41a, 42a and 43a, the transportation driver rollers 44a, 45a, 47a, 48a and 49a, reversion driver roller 46a and the discharge driver roller 50a) to start rotating (Step S1). Next, the punch 103 is moved to a specified angular wait position (or home position H.P as shown in FIG. 12) (Step S2) such that the position of the punch 103 can always be controlled reliably independent of where the punch 103 was previously.

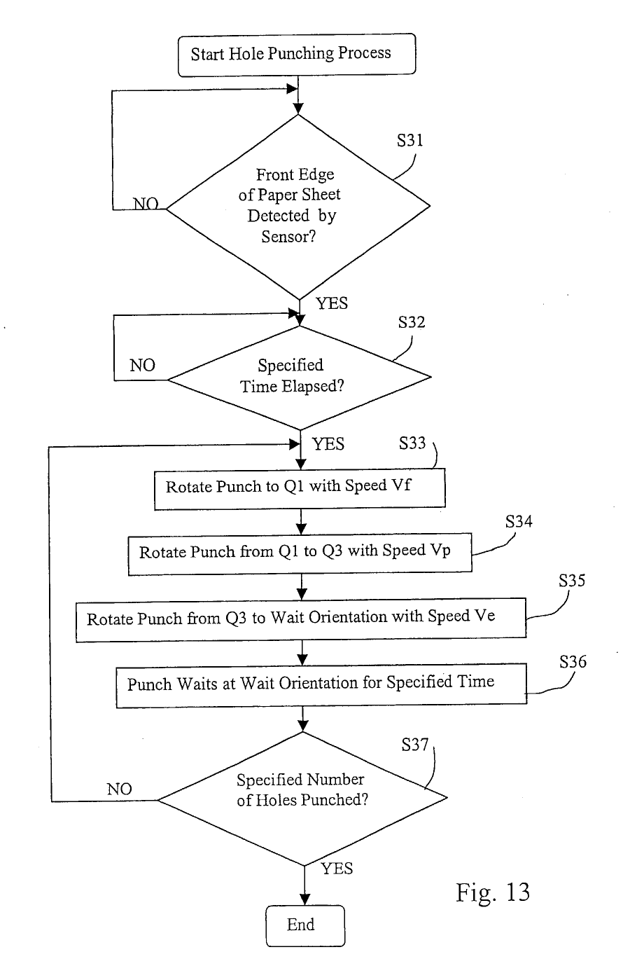

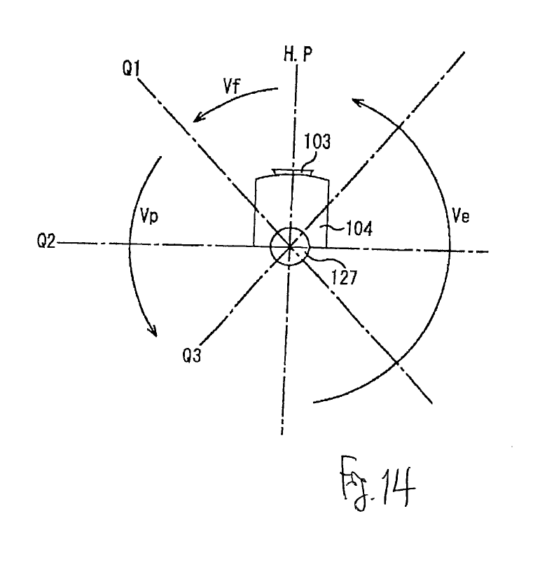

FIG. 12 will be referenced to explain the action of the punch 103 and the die 106 when a hole is punched in the paper sheet P. As explained above, the punch 103 and the die 106 are moving in synchronism and in mutually opposite directions. FIG. 12A shows the moment when the punching is about to start, FIG. 12B shows the moment at the time of punching and FIG. 13C shows the moment at the end of the punching operation. As explained above, the paper sheet P is transported in the direction of arrow Y, and the punch 103 is waiting at its wait orientation H.P when it is not engaging in a punching operation. Orientations Q1, Q2 and Q3 indicate respectively the orientation of the punch 103 at the beginning of, during and at the end of a punching operation. Explained more in detail, Q1 is the orientation when the paper sheet P begins to be nipped between the holder member 104 and the die 106 and Q3 is the orientation when the paper sheet P becomes freed from the nipping by the holder member 104 and the die 106. In other words, the paper sheet P remains nipped between the holder member 104 and the die 106 from the beginning to the end of a hole punching operation. Thus, the paper sheet P is prevented from fluttering during the entire course of the punching operation such that a hole can be created in a stable manner.

The width of the die 106 in the direction parallel to the direction of transportation of the paper sheet P is indicated by W1 and that of the holder member 104 in the same direction is indicated by W2 (as shown also in FIG. 6). They are designed such that W1>W2 in order to prevent the paper sheet P from being folded as it is pressed by the holder member 104 against the die 104 at the beginning or at the end of the punching operation. The depths D1 and D2 respectively of the die 106 and the holder member 104 as shown in FIGS. 6 and 7 are also designed such that D1>D2 for the same reason. These conditions, however, need to be satisfied only on the surfaces contacting the paper sheet P.

With reference again to the flowchart of FIG. 11, the CPU 141 undertakes to carry out the punching operation in Step S3, a detail of which is explained with reference to another flowchart shown in FIG. 13.

The CPU 141 is initially waiting until a signal is received from the paper sensor 105. When a detection signal is received from the paper sensor, indicating that the paper sheet P has been detected (YES in Step S31), the punch 103 is caused to wait at the wait orientation H.P for a specified length of time (Step S32). This specified length of time is calculated by the CPU 141 from the size of the paper sheet P, the distance between the front edge of the paper sheet P and the first hole A (with reference to FIG. 10), the angle between the wait orientation H.P and the orientation Q2, peripheral speed of the punch 103, and the speed of transportation of the paper sheet P. In other words, the distance between the front edge of the paper sheet P and the first hole A can be varied by adjusting the wait time of the punch 103 at its wait orientation H.P.

When an internal clock (not shown) indicates that the specified wait time has elapsed (YES in Step S32), the CPU 141 rotates the punch 103 from the wait orientation H.P to the start orientation Q1 at a rotational speed of Vf (Step S33). During this time, the paper sheet P begins to be nipped between the holder member 104 and the die 106.

Next, the CPU 141 carries out the punching operation by rotating the punch 103 at another rotational speed of Vp from the start orientation Q1 to the end orientation Q3 (Step S34). At the end of this period, the paper sheet P is freed from the nipping between the holder member 104 and the die 106. Thereafter, the punch 103 is rotated from the end orientation Q3 to the wait orientation H.P at a rotational speed indicated as Ve (Step S35) and waits for the next punching command (Step S36).

FIG. 14 shows graphically the rotational speeds of the punch 103 described above. When the paper processing apparatus 2 is operated so as to carry out the punching process while the paper sheet P is being transported, the peripheral speed of the punch 103 during the punching operation must match the speed of transportation of the paper sheet P within an allowable range. During the period over which the holder member 104 and the die 106 are nipping the paper sheet P, the peripheral speed of the punch 103 must match the speed of transportation of the paper sheet P within an allowable range in order that the former will not affect the latter. Thus, the CPU 141 functions so as to synchronize the peripheral speed Vp of the punch 103 and the speed of transportation of the paper sheet P within a specified allowable range between the start orientation Q1 and the end orientation Q3.

At orientations not within the range between the start orientation Q1 and the end orientation Q3, there is no need to synchronize the peripheral speed Vp of the punch 103 and the speed of transportation of the paper sheet P. If the distance between the holes to be punched is not equal to the circumferential length of the punch 103 and if the peripheral speed of the punch 103 and the speed of transportation of the paper sheet P are matched within all ranges of the rotation of the punch 103, it may happen that the punch 103 does not rotate in time for the next punching process. This is why the CPU 141 rotates the punch 103 at a faster speed than the speed of transportation of the paper sheet P at orientations not within the range between the start orientation Q1 and the end orientation Q3. Thus, the speed of the punch 103 is varied as explained above and illustrated in FIG. 14, where Vp<Vf, Ve such that a constant pitch can be kept between the holes.

With reference back to FIG. 13, the CPU 141 counts a specified length of time by means of its internal clock to keep the punch 103 waiting at the wait orientation H.P (Step 36). This specified length of time is calculated by the CPU 141 from the pitch of the punched holes, the peripheral speed of the punch 103 and the speed of transportation of the paper sheet P. Thereafter, if the specified number of holes have not yet been punched (NO in Step S37), the program returns to Step S33 and the subsequent steps are repeated. If it is determined that the specified number of holes have been punched (YES in Step S37), the program returns to Step S4 in the flowchart of FIG. 11 and waits until the reversion sensor 21 outputs a signal to indicate that the back edge of the paper sheet P has been detected (YES in Step S4). After a specified length of time has elapsed thereafter, the solenoid 143 for the motion reversing unit 14 is activated (Step S5) to rotate the reversion driver roller 46a such that the arcuate portion of its periphery will face the transportation path. This specified length of time after the reversion sensor 21 detects the back edge of the paper sheet P is determined to be sufficiently long for the paper sheet P to have safely passed the position of the transportation rollers 45.

The paper sheet P is thereafter further transported in the downstream direction by means of the transportation driver and follower rollers 45a and 45c. The CPU 141 waits until the discharge sensor 22 detects the back edge of the paper sheet P (YES in Step S6) and, if it is determined that not all of the originally specified number of paper sheets have been processed (NO in Step S7), the CPU 141 returns to Step S2 and the subsequent steps are repeated. If all of the originally specified number of paper sheets have been processed (YES in Step S7), the CPU 141 controls the roller controller 142 to stop all of the driver rollers (the oblique driver rollers 41a, 42a and 43a, the transportation driver rollers 44a, 45a, 47a, 48a and 49a, reversion driver roller 46a and the discharge driver roller 50a) (Step S8) to complete the processing. The paper sheet P which has passed the discharge sensor 22 is discharged into the tray 15 by means of the discharge rollers 50.

What is claimed is:

1. A hole puncher comprising:
a punching unit having a rotatable punch for punching a hole through a paper sheet at a punching position;
a paper transporting device for transporting the paper sheet from an upstream side to a downstream side generally in a specified direction of paper transportation, said transporting device including:
a paper supplying device disposed on said upstream side of said punching unit for supplying the paper sheet towards said punching unit, the paper sheet having a front edge which reaches said punching unit first; and
a paper discharging device disposed on said downstream side of said punching unit for discharging the paper sheet;
said punching unit punching a first hole on the paper sheet at a specified distance T1 from the front edge, at least one selected from said paper supplying device and said paper discharging device having a clamping device at a distance smaller than said specified distance T1 from said punching position.

2. The hole puncher of claim 1 wherein said punch has a holder member for holding the paper sheet, said holder member having a contact surface for contacting the paper sheet; said punching unit includes a die which is rotatable in synchronism with said punch; said contact surface is shorter than said die both in said direction of paper transportation and in a perpendicular direction to said direction of paper transportation.

3. A hole puncher comprising:
a punching unit having a rotatable punch for punching a hole through a paper sheet;
a plurality of paper transporting devices for transporting the paper sheet from an upstream side to a downstream side generally in a specified direction of paper transportation; and
a guide member for a side edge of the paper sheet to slide along as the paper sheet is transported;
wherein said paper transporting devices include oblique clamping devices which are disposed on said upstream side of said punching unit and serve to apply an oblique force on the paper sheet with respect to said direction of paper transportation and to press the paper sheet onto said guide member and wherein said oblique clamping devices include a cylindrically shaped roller with a shaft oriented obliquely at a specified angle from said direction of paper transportation.

4. The hole puncher of claim 3 wherein said paper transporting devices include a straight transporting device which is disposed closer to said punching unit than any of said oblique clamping devices and serves to transport the paper sheet straight in said direction of paper transportation.
